(19) United States
(12) Patent Application Publication
(10) Pub. No.: US 2026/0161165 A1
(43) Pub. Date: Jun. 11, 2026

(54) DEVICE AND METHOD FOR SAMPLING-BASED PATH PLANNING USING MIDPOINT INTERPOLATION METHOD

(71) Applicant: Dongguk University Industry-Academic Cooperation Foundation, Seoul (KR)

(72) Inventors: Jin Woo JUNG, Seoul (KR); Jin Gu KANG, Seoul (KR); Tea Won KANG, Siheung-si (KR); Yong Sik CHOI, Anyang-si (KR)

(21) Appl. No.: 19/178,815

(22) Filed: Apr. 14, 2025

Related U.S. Application Data
(63) Continuation of application No. PCT/KR2023/013576, filed on Sep. 11, 2023.

(30) Foreign Application Priority Data
Oct. 14, 2022 (KR) 10-2022-0132246

(51) Int. Cl. G05D 1/229; G05D 1/43; G05D 1/622; G05D 1/644

(52) U.S. Cl. CPC G05D 1/229; G05D 1/43; G05D 1/622; G05D 1/644

(57) ABSTRACT

An embodiment relates to a sampling-based path planning technology and, more specifically, to a sampling-based path planning method using a midpoint interpolation method. According to an embodiment, a faster and shorter path plan can be generated even in an environment having an obstacle by using a midpoint interpolation technique. A sampling-based path planning device using midpoint interpolation according to one embodiment comprises: a sampling unit for sampling and inputting coordinates used as a basis for planning a sampling-based path at a random location; a node creation unit for creating a new node on the basis of the input coordinates; and a path setting unit for setting a shortest path by planning a path from a starting point to a destination point using the created node, determining whether the starting point and the destination point of the planned path are connected, and detecting a determined new path.

### STATEMENT REGARDING PRIOR DISCLOSURES BY THE INVENTORS

A non-patent literature entitled, “A Bidirectional Interpolation Method for Post-Processing in Sampling-Based Robot Path Planning” which was published on or around Nov. 8, 2021, is not prior art under 35 U.S.C. 102(b) as being a disclosure made directly or indirectly by the inventor or a joint inventor 1 year or less before the effective filing date of the instant application. A copy of the non-patent literature prior disclosure is being submitted with the instant application in an Information Disclosure Statement pursuant to 37 CFR 1.97 and 1.98.

### CROSS REFERENCE TO RELATED APPLICATION

This application is a Continuation of PCT Patent Application No. PCT/KR2023/013576 filed on Sep. 11, 2023, which claims priority to Korean Patent Application No. 10-2022-0132246, filed on Oct. 14, 2022, in the Korean Intellectual Property Office, the entire contents of which are incorporated herein by reference.

### TECHNICAL FIELD

The present invention relates to a path planning technology based on midpoint interpolation, and more specifically, to a sampling-based path planning device and method using midpoint interpolation.

### BACKGROUND ART

Robot industry means an industry that manufactures, sells, and services finished intelligent robot products or robot parts, and is used in various fields such as medical, household, and industrial purposes. Robots plan their own moving paths to perform a specific task, and this is called path planning.

In a commonly used sampling-based path planning method among path planning methods, sampling is performed at unspecified locations. A path is generated between a starting point and a destination point while going through a process of creating a new waypoint node based on the sampling and connecting the new waypoint node to an existing path.

Although the sampling-based path planning method has an advantage of generating paths more quickly in an environment having a certain obstacle, since sampling is performed randomly, there is a problem in that the generated paths proceed in various directions without considering optimality of the generated paths.

The background technology of the present invention is published in Korean Patent Registration No. 10-1339480.

### DISCLOSURE OF INVENTION

### Technical Problem

Therefore, the present invention has been made in view of the above problems, and it is an object of the present invention to provide a sampling-based path planning device and method using midpoint interpolation, which generates a faster and shorter path plan even in an environment having an obstacle by using a midpoint interpolation technique.

The technical problems to be solved by the present invention are not limited to the technical problems mentioned above, and unmentioned other technical problems can be clearly understood by those skilled in the art from the following descriptions.

### Technical Solution

To accomplish the above object, according to one aspect of the present invention, there is provided a sampling-based path planning method using midpoint interpolation.

A sampling-based path planning device and method using midpoint interpolation according to an embodiment of the present invention may comprise: a sampling unit for sampling and inputting coordinates used as a basis for planning a sampling-based path at a random location; a node creation unit for creating a new node on the basis of the coordinates input from the sampling unit; and a path setting unit for setting a shortest path by identifying a path from the node creation unit, planning a path, determining whether the starting point and the destination point of the identified path are connected, and detecting a new path.

### Advantageous Effects

According to an embodiment of the present invention, a faster and shorter path plan can be generated even in an environment having an obstacle by using a midpoint interpolation technique.

It should be understood that the effects of the present invention are not limited to the effects described above, but include all effects that can be inferred from the configurations of the invention described in the descriptions or claims of the present invention.

### BRIEF DESCRIPTION OF THE DRAWINGS

FIG. 1 is a view for explaining a sampling-based path planning device using midpoint interpolation according to an embodiment of the present invention.

FIGS. 2 and 3 are views for explaining a sampling-based path planning method using midpoint interpolation according to an embodiment of the present invention.

FIGS. 4 and 5 are views for explaining a path setting method of a sampling-based path planning device using midpoint interpolation according to an embodiment of the present invention.

FIG. 6 is a view showing an example of optimal shortest paths derived from a sampling-based path planning device using midpoint interpolation according to an embodiment of the present invention.

FIG. 7 is a diagram of a computing device for implementing a descriptor generation method and a descriptor generation apparatus according to an embodiment of the present invention.

### BEST MODE FOR CARRYING OUT THE INVENTION

The present invention may have various modifications and various embodiments, and specific embodiments are illustrated in the drawings and described in detail through detailed description. However, this is not intended to limit the present invention to the specific embodiments, and it should be understood that the present invention includes all modifications, equivalents, and substitutes included in the spirit and technical scope of the present invention. When it is determined in describing the present invention that a detailed description of a related known technology may unnecessarily obscure the gist of the present invention, the detailed description will be omitted. In addition, singular expressions used in the specification and claims should be construed to generally mean “one or more” unless mentioned otherwise.

Throughout the specification, when a part is said to be “connected (coupled, contacted, joined)” to another part, this includes cases where they are “indirectly connected” with intervention of other members therebetween, as well as cases where they are “directly connected”. In addition, when a part is said to “include” a certain component, this does not mean that other components are excluded, but mean that other components may be further provided, unless stated otherwise specifically.

The terms used in this specification are used only to describe specific embodiments, not to limit the present invention. Singular expressions include plural expressions unless the context clearly indicates otherwise. In this specification, it should be understood that the terms “include”, “have”, and the like are intended to specify the presence of features, numbers, steps, operations, components, parts, or combinations thereof described in the specification, not to exclude in advance the possibility of presence or addition of one or more other features, numbers, steps, operations, components, parts, or combinations thereof.

Hereinafter, the present invention will be described with reference to the accompanying drawings. However, the present invention may be implemented in various different forms and is not limited to the embodiments described herein. In addition, in order to clearly describe the present invention in the drawings, parts that are not related to the description are omitted, and similar drawing reference numerals are assigned to similar parts throughout the specification.

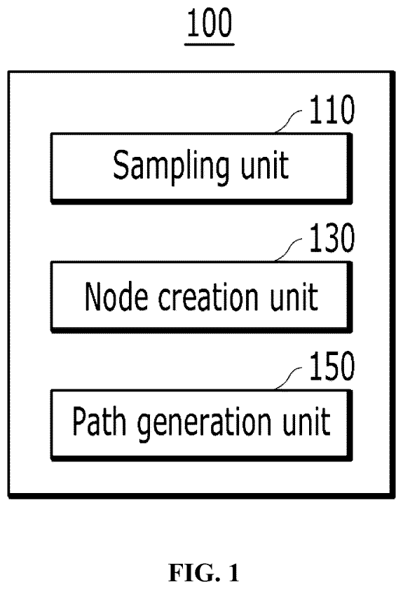

FIG. 1 is a view for explaining a sampling-based path planning device using midpoint interpolation according to an embodiment of the present invention.

Referring to FIG. 1, a sampling-based path planning device using midpoint interpolation according to an embodiment of the present invention includes a sampling unit 110, a node creation unit 130, and a path generation unit 150.

The sampling unit 110 randomly samples and inputs the coordinates used as a basis for planning a sampling-based path. The sampling unit 110 may be configured as a set including at least three coordinate nodes used as a basis for planning a sampling-based path, but it is not limited thereto. The set including the coordinate nodes of the sampling unit 110 is configured of a plurality of nodes, and may be an element for using midpoint interpolation.

The node creation unit 130 creates a new node (Child) on the basis of the coordinates input from the sampling unit. The node creation unit 130 may find a parent node, i.e., an upper node of the new node, and an ancestor node, i.e., an upper node of the parent node, with reference to the new reference node. For example, when the node creation unit 130 sets the reference node (Child) as Node 0, the parent node (Parent) and the ancestor node (Ancestor; parent node of the parent node) may be set as Node 1 and Node 2.

The path generation unit 150 sets a shortest path by identifying a path on the basis of the new node (Child) created by the node creation unit, planning a path, determining whether the starting point and the destination point of the identified path are connected, and detecting a new path. In addition, the path generation unit 150 may plan a path using a midpoint interpolation technique that estimates an unknown value using values known in advance.

The path generation unit 150 may determine whether there is an obstacle on the edge of the reference node and the ancestor node, and add the reference node and the parent node to a shortest path node set (T) when there is an obstacle on the edge. In addition, the path generation unit 150 stores the distance from the parent node to the edge of the reference node and the ancestor node in D.

The path generation unit 150 may add the reference node and the ancestor node to the shortest path set (T) when there is no obstacle on the edge of the reference node and the ancestor node.

For example, when there is no overlapping obstacle between the reference node (Node 0) and the ancestor node (Node 2), the path generation unit 150 may immediately connect the nodes and delete the parent node (Node 1) from the shortest path node set (T).

The path generation unit 150 may, for example, update Node 2, i.e., the ancestor node of the parent node (Node 1), as the parent node, and update Node 3, i.e., the upper node of Node 2, as the ancestor node.

For example, when the edge of the reference node (Node 0) and the ancestor node (Node 2) overlaps with an obstacle, the path generation unit 150 determines whether the distance D from the parent node (Node 1) to the edge of the reference node (Node 0) and the ancestor node (Node 2) is greater than a threshold value.

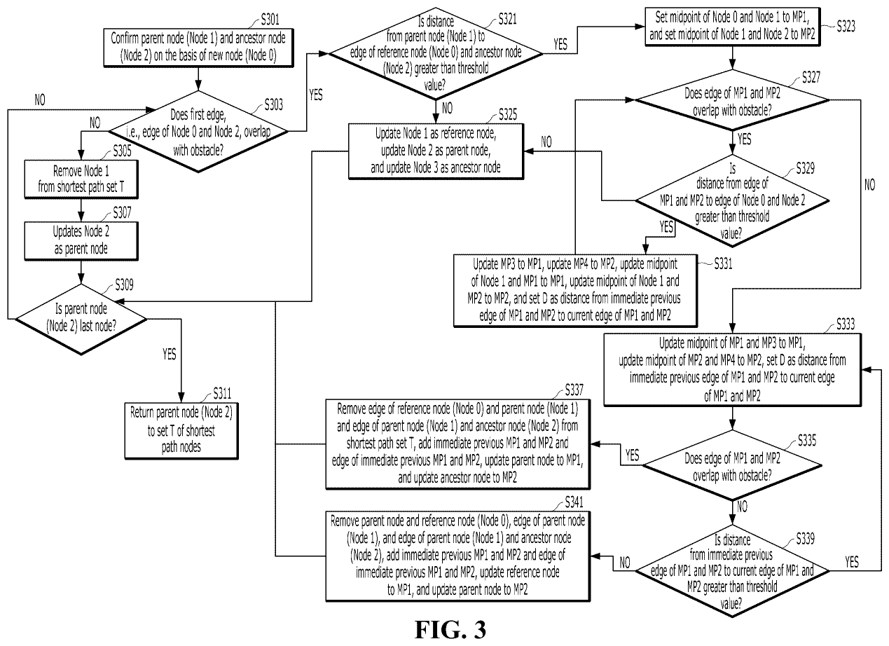

Then, when the distance D from the parent node (Node 1) to the edge of the reference node (Node 0) and the ancestor node (Node 2) is smaller than the threshold value, the path generation unit 150 may change the reference node to the parent node and update the existing parent node as the ancestor node. When the distance D from the parent node (Node 1) to the edge of the reference node (Node 0) and the ancestor node (Node 2) is greater than the threshold value, midpoint interpolation is performed. A detailed description of the midpoint interpolation technique will be described below with reference to FIGS. 3 to 5.

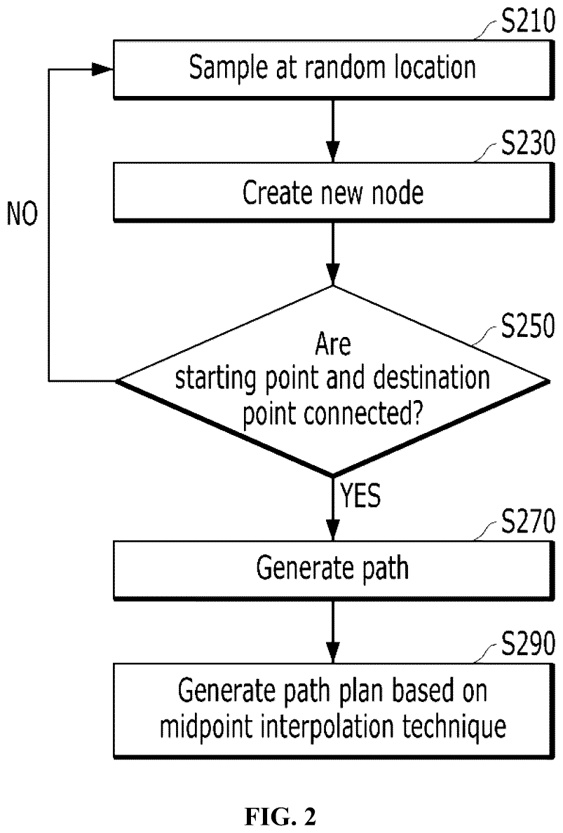

FIGS. 2 and 3 are views for explaining a sampling-based path planning method using midpoint interpolation according to an embodiment of the present invention.

Referring to FIG. 2, at step S210, the sampling-based path planning device using midpoint interpolation first performs a step of sampling at a random location.

At step S230, the sampling-based path planning device using midpoint interpolation creates a new node by the step of sampling at a random location.

At step S250, the sampling-based path planning device using midpoint interpolation determines whether the starting point and the destination point of the node are connected, and when the starting point and the destination point are not connected, the device returns to step S210. When the starting point and the destination point of the node are connected at step S250, the sampling-based path planning device using midpoint interpolation performs step S270.

At step S270, the sampling-based path planning device using midpoint interpolation generates a path by determining that the start point and the destination point are connected.

At step S290, the sampling-based path planning device using midpoint interpolation generates a path plan based on a midpoint interpolation technique by the step of generating a new node.

Referring to FIG. 3, at step S301, the sampling-based path planning device using midpoint interpolation may find Node 1, i.e., the parent node of the reference node, and Node 2 as the ancestor node, i.e., the parent node of the parent node, on the basis of Node 0, i.e., a newly generated node.

At step S303, the sampling-based path planning device using midpoint interpolation determines whether a first edge, which is the edge of Node 0, i.e., the reference node, and Node 2, i.e., the ancestor node, overlaps with an obstacle. When an obstacle overlaps with the first edge at step S303, the sampling-based path planning device using midpoint interpolation proceeds to step S321. When the obstacle does not overlap with the first edge at step S303, the sampling-based path planning device using midpoint interpolation proceeds to step S305.

At step S305, the sampling-based path planning device using midpoint interpolation removes Node 1, i.e., the parent node, from the shortest path set T.

At step S307, the sampling-based path planning device using midpoint interpolation updates Node 2 as the parent node.

At step S309, the sampling-based path planning device using midpoint interpolation determines whether the parent node (Node 2) updated at step S307 is the last node. When the parent node (Node 2) is determined as the last node at step S309, the sampling-based path planning device using midpoint interpolation performs step S311 of returning the parent node (Node 2) to the set T of shortest path nodes. At this point, the sampling-based path planning device using midpoint interpolation according to the present invention includes the shortest path set T, which is a set of nodes forming random locations. When the parent node (Node 2) is not determined as the last node at step S309, the sampling-based path planning device using midpoint interpolation returns to step S303.

When an obstacle overlaps with the first edge at step S303, the sampling-based path planning device using midpoint interpolation performs step S321 of determining whether the distance from the parent node (Node 1) to the edge of the reference node (Node 0) and the ancestor node (Node 2) is greater than a threshold value.

When the distance D from the parent node (Node 1) to the edge of the reference node (Node 0) and the ancestor node (Node 2) determined at step S321 is greater than the threshold value, the sampling-based path planning device using midpoint interpolation performs step S323 of performing midpoint interpolation. On the other hand, when the distance from the parent node (Node 1) to the edge of the reference node (Node 0) and the ancestor node (Node 2) determined at step S321 is smaller than the threshold value, the sampling-based path planning device using midpoint interpolation updates Node 0, i.e., the reference node, to Node 1 at step S325. In addition, the parent node (Node 1) is updated to Node 2, and the ancestor node (Node 2) is updated to Node 3. Thereafter, step S325 proceeds to step S309 to determine whether the parent node (Node 2) is the last node, and when the parent node is the last node, step S311 is performed, and when the parent node is not the last node, the process returns to step S303.

At step S323, the sampling-based path planning device using midpoint interpolation sets the midpoint of Node 0 and Node 1 as MP1, and sets the midpoint of Node 1 and Node 2 as MP2. In addition, at step S323, the sampling-based path planning device using midpoint interpolation adds the distance from the edge of MP1 and MP2 to the edge of the reference node (Node 0) and the ancestor node (Node 2) to D. Thereafter, the reference node (Child) Node 0 is set as the midpoint MP3, and the midpoint MP4 is stored in the ancestor node (Node 2). At this point, the sampling-based path planning device using midpoint interpolation according to the present invention includes a set D of distances to nodes or edges.

When the edge of MP1 and MP2 overlaps with an obstacle at step S327 and the distance D between the edge of MP1 and MP2 and the edge of Node 0 and Node 2 is greater than the threshold value at step S329, the sampling-based path planning device using midpoint interpolation updates MP3 to MP1 and MP4 to MP2, and updates the midpoint of the parent node (Node 1) and MP1 to MP1 and the midpoint of the parent node (Node 1) and MP2 to MP2. In addition, the process of updating D to the distance from the immediate previous edge of MP1 and MP2 to the current edge of MP1 and MP2 is repeated. When the distance D between the edge of MP1 and MP2 and the edge of Node 0 and Node 2 is smaller than the threshold value at step S329, step S325 is performed. At step S325, the reference node (Node 0) is updated to Node 1. In addition, the parent node (Node 1) is updated to Node 2, and the ancestor node (Node 2) is updated to Node 3. Thereafter, step S325 proceeds to step S309 to determine whether the parent node (Node 2) is the last node. When the parent node is the last node, step S311 is performed, and when the parent node is not the last node, the process returns to step S303.

When the edge of MP1 and MP2 does not overlap with an obstacle at step S327, the sampling-based path planning device using midpoint interpolation performs step S333. When the edge of MP1 and MP2 does not overlap with an obstacle at step S327, the sampling-based path planning device using midpoint interpolation performs a process of generating a path to be close to the obstacle.

At step S333, the midpoint of MP1 and MP3 is updated to MP1, and the midpoint of MP2 and MP4 is updated to MP2, and D is updated to the distance from the immediate previous edge of MP1 and MP2 to the current edge of MP1 and MP2.

At step S335, the sampling-based path planning device using midpoint interpolation determines whether the edge of MP1 and MP2 overlap with an obstacle. When the edge of MP1 and MP2 overlaps with an obstacle at step S335, the sampling-based path planning device using midpoint interpolation performs step S337.

At step S337, the sampling-based path planning device using midpoint interpolation removes the edge of the reference node (Node 0) and the parent node (Node 1) and the edge of the parent node (Node 1) and the ancestor node (Node 2), adds the immediate previous MP1 and MP2 and the edge of the immediate previous MP1 and MP2, and updates the parent node to MP1 and the ancestor node to MP2. Thereafter, at step S337, the sampling-based path planning device using midpoint interpolation proceeds to step S309 to determine whether the parent node (Node 2) is the last node, and proceeds to step S311 when the parent node is the last node and returns to step S303 when the parent node is not the last node.

When the edge of MP1 and MP2 does not overlap with an obstacle at step S335, the sampling-based path planning device using midpoint interpolation performs step S339.

When the distance D between the immediate previous edge of MP1 and MP2 and the current edge of MP1 and MP2 is greater than the threshold value at step S339, the sampling-based path planning device using midpoint interpolation returns to step S333. When the distance D between the immediate previous edge of MP1 and MP2 and the current edge of MP1 and MP2 is smaller than the threshold value at step S339, the sampling-based path planning device using midpoint interpolation performs step S341.

At step S341, the sampling-based path planning device using midpoint interpolation removes the parent node and the reference node (Node 0), the edge of the parent node (Node 1) and the reference node (Node 0),

and the edge of the parent node (Node 1) and the ancestor node (Node 2), and adds immediate previous MP1 and MP2 and the edge of immediate previous MP1 and MP2. In addition, at step S341, the sampling-based path planning device using midpoint interpolation updates the reference node to MP1 and the parent node to MP2. Thereafter, step S341 proceeds to step S309 to determine whether the parent node (Node 2) is the last node, and proceeds to step S311 when the parent node is the last node, and returns to step S303 when the parent node is not the last node.

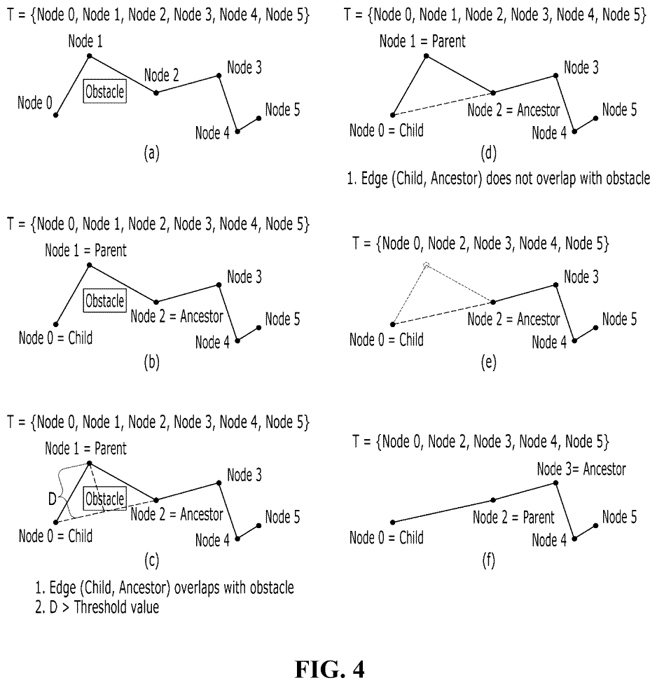

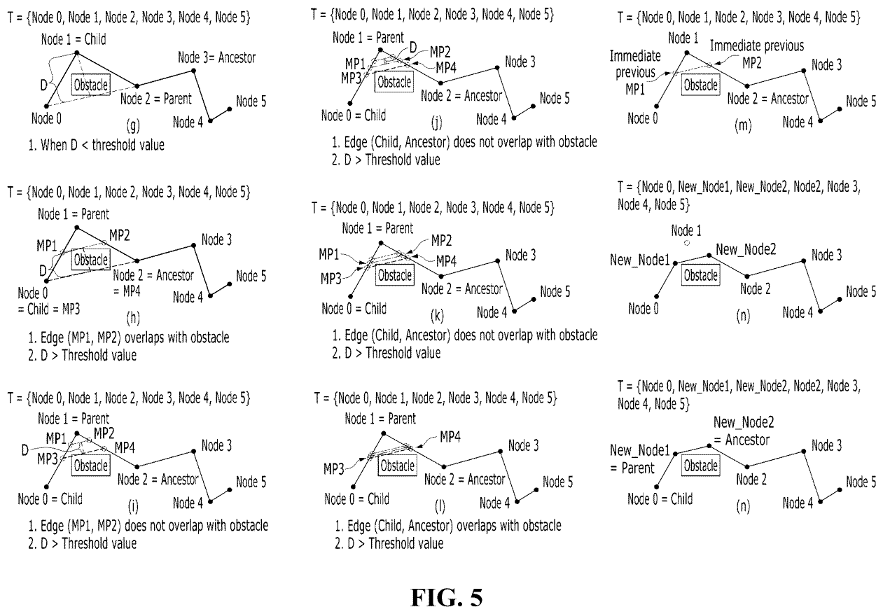

FIGS. 4 and 5 are views for explaining a path setting method of a sampling-based path planning device using midpoint interpolation according to an embodiment of the present invention.

Referring to (a) of FIG. 4, when the reference node (Child) is set as Node 0 in a part of the path as shown in (b) of FIG. 4, the sampling-based path planning device using midpoint interpolation according to the present invention sets the parent node (Parent) and the ancestor node (parent node of the parent node) as Node 1 and Node 2. In addition, as shown in (c) of FIG. 4, the distance D from the parent node (Node 1) to the edge of the reference node (Node 0) and the ancestor node (Node 2) is set. Thereafter, it is determined whether the edge of the reference node (Node 0) and the ancestor node (Node 2) overlaps with an obstacle.

At this point, referring to (d) and (e) of FIG. 4, the sampling-based path planning device using midpoint interpolation according to an embodiment of the present invention directly connects the reference node (Node 0) and the ancestor node (Node 2) since there is no overlapping obstacle therebetween and removes the parent node (Node 1) from the shortest path node set (T). In addition, referring to (f) of FIG. 4, the edge of the reference node (Node 0) and the parent node (Node 1) and the edge of the parent node (Node 1) and the ancestor node (Node 2) are deleted, the parent node is updated as the ancestor node, and the reference node (Node 0) and the parent node (Node 2) are added.

Referring to (g) of FIG. 5, when Node 0, i.e., the reference node, and Node 2, i.e., the parent node, overlap with an obstacle, the sampling-based path planning device using midpoint interpolation according to an embodiment of the present invention compares the length of D with a threshold value. At this point, when D is smaller than the threshold value, Node 0 (child), i.e., the reference node, is changed to Node 1, and the parent node and ancestor node are updated respectively. When D is larger than the threshold value, midpoint interpolation is used. As shown in (h) of FIG. 5, the midpoint (Child, Parent) of the reference node (Child) Node 0 and the parent node (Parent) Node 1 is stored in the midpoint MP1, and the midpoint (Parent, Ancestor) of the parent node (Parent) Node 1 and the ancestor node (Ancestor) Node 2 is set in the midpoint MP2. Thereafter, after adding the distance D between the edge of the midpoints MP1 and MP2 and the edge of the reference node (Child) and the ancestor node (Ancestor), the reference node (Child) Node 0 is set as the midpoint MP3, and the midpoint MP4 is stored in the ancestor node (Ancestor) Node 2. At this point, referring to (i) of FIG. 5, when the edge of midpoints MP1 and MP2 overlap with an obstacle and D is larger than the threshold value, MP3 and MP4 are updated to MP1 and MP2, respectively. Thereafter, with reference to the parent node, the midpoint of the parent node and MP1 is set in MP1, and MP2 is updated to the midpoint of the parent node and MP2, and the process of updating D to the distance from the immediate previous edge of MP1 and MP2 to the current edge of MP1 and MP2 is repeated. When the length of D becomes smaller than the threshold value as the above process is repeated, the reference node (Child) is updated as the parent node (Parent), and the parent node (Parent) and the ancestor node (Ancestor) are updated respectively. At this point, when the parent node is the last node, the process ends after returning the shortest path node set (T).

Referring to (j) and (k) of FIG. 5, when the edge of MP1 and MP2 does not overlap with an obstacle, a process of generating a path to be close to the obstacle is performed. The midpoint of MP1 and MP3 is updated to MP1, and the midpoint of MP2 and MP4 is updated to MP2. Thereafter, referring to (1) of FIG. 5, D is updated to the distance from the immediate previous edge of MP1 and MP2 to the current edge of MP1 and MP2.

Referring to (m) to (o) of FIG. 5, when the edge of MP1 and MP2 overlaps with an obstacle, the edge of the reference node and the parent node and the edge of the parent node and the ancestor node are removed from the shortest path set (T), and the immediate previous MP1 and the immediate previous MP2 are updated in the shortest path set (T). Thereafter, the edge of the immediate previous MP1 and the immediate previous MP2 is added, and the immediate previous MP1 (New_Node 1) is updated as the parent node, and the immediate previous MP2 (New_Node 2) is updated as the ancestor node.

For example, when the edge of MP1 and MP2 does not overlap with an obstacle, it is determined whether the distance D between the immediate previous edge of MP1 and MP2 and the current edge of MP1 and MP2 is greater than the threshold value, and when the distance D is not greater than the threshold value, the parent node, the edge of the reference node and the parent node, and the edge of the parent node and the ancestor node are removed from the shortest path set (T). Thereafter, MP1, MP2, and the immediate previous edge of MP1 and MP2 are updated in the shortest path set (T), and the reference node (Child) is updated to MP1, and the parent node (Parent) is updated to MP2. For example, when the distance D between the immediate previous edge of MP1 and MP2 and the current edge of MP1 and MP2 is greater than the threshold value, the process of updating MP1 and MP2 to the midpoint of MP1 and MP3 and the midpoint of MP2 and MP4 respectively is repeated.

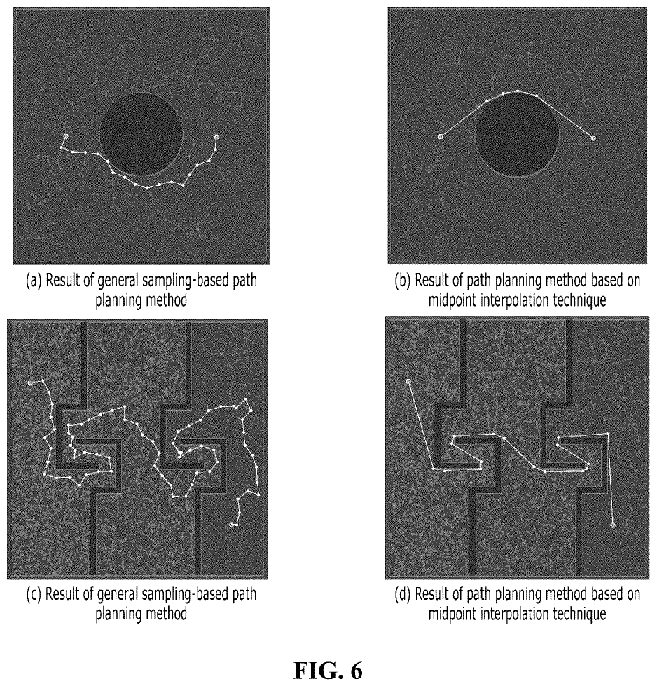

FIG. 6 is a view showing an example of optimal shortest paths derived from a sampling-based path planning device using midpoint interpolation according to an embodiment of the present invention.

Referring to FIG. 6, in the sampling-based path planning device using midpoint interpolation according to the present invention, methods (b) and (d) may generate a shortest path that is shorter and simpler, compared to the path planning methods (a) and (c).

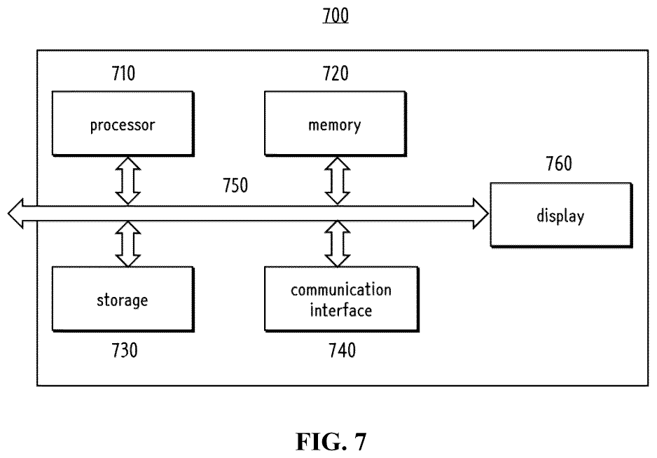

FIG. 7 shows a computing device implementing a descriptor generation method and device according to an embodiment of the present invention.

The embodiments of the present invention described in FIGS. 1 to 6 may be implemented as a computing device 700 operating by at least one processor.

The computing device 700 may include a processor 710, a memory 720, a storage 730, a communication interface 740, a system interconnect 750, and a display 760.

The processor 710 includes a central processing unit (CPU), a microprocessor unit (MPU), a micro controller unit (MCU), a graphic processing unit (GPU), and an application processing unit (APU).

The memory 720 interacts with the processor 710 perform a function of storing data and quickly accessing necessary information so that the program may be executed efficiently. The memory 720 includes at least one among a register, a cache memory, a main memory, a read-only memory, a virtual memory, and a nonvolatile memory.

The storage 730 performs a function of permanently storing and managing data. The storage is used to preserve data even after the computing system is turned off or rebooted, and store operating systems, applications, user files, and the like. The storage 730 includes at least one among a hard disk drive (HDD), a solid-state drive (SSD), an optical disk, a network storage, and a cloud storage.

The communication interface 740 provides a path for transmitting and receiving data between various devices inside and outside the computing system. The communication interface 740 may support at least one communication method among Universal Serial Bus (USB), Peripheral Component Interconnect Express (PCIe), Serial ATA (SATA), Ethernet, Wi-Fi, Thunderbolt, and High-Definition Multimedia Interface (HDMI).

The system interconnect 750 performs a function of transmitting and receiving data and signals among various components within the computing system. The system interconnect 750 may support at least one method among a bus, a point-to-point interconnect, a crossbar switch, and a network-on-chip (NoC).

The display 760 is an output device of the computing system and performs a function of providing visual information to users.

According to the configuration described above, a program according to an embodiment of the present invention is executed based on instructions executed by the processor 710, and may be stored in the memory 720 or the storage 730.

The description of the present invention described above is for illustrative purpose, and those skilled in the art will understand that the present invention can be easily modified into other specific forms without changing the technical spirit or essential features of the present invention. Therefore, it should be understood that the embodiments described above are exemplary and not restrictive in all respects. For example, each component described as a single component may be implemented to be distributed, and similarly, components described as being distributed may be implemented in a combined form.

The scope of the present invention is indicated by the claims described below, and all changes or modifications derived from the meaning and scope of the claims and their equivalent concepts should be interpreted as being included in the scope of the present invention.

The mode for carrying out the invention has been described together with the best mode for carrying out the invention.

### INDUSTRIAL APPLICABILITY

The present invention relates to a path planning technology based on midpoint interpolation, and more specifically, to a sampling-based path planning device and method using midpoint interpolation. Since the present invention can be used in various ways, it has industrial applicability.

What is claimed is:

1. A sampling-based path planning device using midpoint interpolation, the device comprising:
a sampling unit for sampling and inputting coordinates used as a basis for planning a sampling-based path at a random location;
a node creation unit for creating a new node on the basis of the input coordinates; and
a path setting unit for setting a shortest path by planning a path from a starting point to a destination point using the created node, determining whether the starting point and the destination point of the planned path are connected, and detecting a determined new path.

2. The device according to claim 1, wherein the sampling unit is configured as a set including at least three nodes used as a basis for planning a sampling-based path.

3. The device according to claim 2, wherein the set is configured of nodes.

4. The device according to claim 1, wherein the node creation unit finds a parent node, i.e., an upper node of the new node, and an ancestor node, i.e., an upper node of the parent node.

5. The device according to claim 1, wherein the path generation unit plans a path using a midpoint interpolation technique.

6. The device according to claim 5, wherein the path generation unit sets the parent node as a current ancestor node, and generates a new path through midpoint interpolation when an edge of a reference node and the ancestor node overlaps with an obstacle.

7. A sampling-based path planning method using midpoint interpolation performed by a sampling-based path planning device, the method comprising the steps of:
creating a 0-th node, i.e., a new node;
finding a first node, i.e., a parent node, and a second node, i.e., an ancestor node, using the 0-th node as a child node;
determining whether a first edge of the 0-th node and the second node overlaps with an obstacle; and
putting the 0-th node and the second node into a shortest path set when the first edge does not overlap with an obstacle.

8. The method according to claim 7, further comprising the step of removing the first node from the shortest path set.

9. The method according to claim 7, further comprising the step of updating the second node as a parent node, and determining whether the second node is a last node and updating the second node.

10. The method according to claim 7, further comprising the step of determining whether the first edge of the 0-th node and the second node overlaps with an obstacle, and comparing, when the first edge overlaps with an obstacle, a distance from the first node to the edge of the 0-th node and the second node with a threshold value.

11. The method according to claim 10, further comprising the step of setting a midpoint of the 0-th node and the first node as a first midpoint, and setting, when the distance from the first node to the edge of the 0-th node and the second node is greater than the threshold value, a midpoint of the first node and the second node as a second midpoint.

12. The method according to claim 11, further comprising the step of determining whether an edge of the first midpoint and the second midpoint overlaps with an obstacle, and comparing, when the edge of the first midpoint and the second midpoint overlaps with an obstacle, a distance from the edge of the first midpoint and the second midpoint to an edge of the first node and the second node with a threshold value.

13. A computer program recorded on a computer-readable recording medium to execute the sampling-based path planning methods using midpoint interpolation according to claim 7.
